(19) United States
(12) Patent Application Publication
(10) Pub. No.: US 2023/0026002 A1
(43) Pub. Date: Jan. 26, 2023

(54) NON-ACOUSTIC SENSOR FOR ACTIVE NOISE CANCELLATION

(71) Applicants: Joseph Sylvester CHANG, Singapore (SG); Chai Lung LEE, Singapore (SG); AUDIO ZOOM PTE LTD, Singapore (SG)

(72) Inventors: Joseph Sylvester CHANG, Singapore (SG); Chai Lung LEE, Singapore (SG); Tong GE, Singapore (SG); Sebastian MingJie CHANG, Canberra (AU)

(21) Appl. No.: 17/788,735

(22) PCT Filed: Dec. 23, 2020
(86) PCT No.: PCT/SG2020/050778

§ 371 Date: Jun. 23, 2022

(30) Foreign Application Priority Data
Dec. 23, 2019 (SG) 10201912952W

(51) Int. Cl. G10K 11/178; H04R 1/10

(52) U.S. Cl. CPC G10K 11/17823; H04R 1/1083; G10K 11/17873; G10K 11/17854; H04R 2460/01; G10K 2210/1081; G10K 2210/129; G10K 2210/3226

(57) ABSTRACT

The invention involves the employment of a non-acoustical transducer embodying one non-acoustical sensor (or more non-acoustical sensors) which is adapted to sense acoustical sounds. The invention for realizing an Active Noise Cancellation device involves the replacement of the acoustic microphone (or microphones) in the said device with the aforesaid one non-acoustical sensor (or more sensors).

### BACKGROUND OF THE INVENTION

### 1. Field of the Invention

Embodiments of the invention generally relate to Active Noise Cancellation where the acoustical sensing microphone or array of microphones therein is replaced by a non-acoustical sensing sensor that is adapted to sense acoustical sounds.

### 2. Description of the Related Art

Active noise cancellation (ANC) or active noise reduction (ANR), by means of generating an acoustic signal of opposing phase to the noise, is generally effective. The technical art for ANC is well established and mature, with numerous commercial devices, including in-ear (earphones) and over-the-ear (headphones) ANC devices.

A commonality between all prior-art ANC devices is the use of the acoustical microphone or a multiplicity of acoustical microphones as the acoustical sensing sensor. Microphones and prior-art ANC devices suffer from several shortcomings. First, the linearity of the phase response over a wider frequency bandwidth is insufficient. Second, high directivity at the entry of the ear canal of the user's ear cannot be achieved with small form-factor microphones. Third, the acoustical sensitivity in the infrasound range is heavily attenuated. Fourth, the sounds picked up by the human body cannot be sensed. Finally, there is a general desire for even higher noise reduction.

There are two other shortcomings in prior-art ANC devices that remain unaddressed. First, some ambient acoustical sounds, including that in the infrasound range, are absorbed by the human body. Prior-art ANC devices do not detect this and do not attempt to cancel this noise. Second, because of the noise cancellation provided by the ANC, the user of the ANC is typically unable to estimate or properly perceive the volume of his voice when he talks, particularly in noisy environments. This is because, psycho-acoustically, humans usually speak louder than the background noise but because of the noise cancellation provided by the ANC, the user typically underestimates the intensity (sound pressure level) of the noise.

In short, all prior-art ANC devices depend on the use of acoustical microphones and suffer from the aforesaid shortcomings, and there are two other aforesaid shortcomings that remain unresolved.

It is also particularly pertinent to note that prior-art ANC devices have not employed a non-acoustical sensing sensor (but adapted to sense acoustical sounds) to replace the acoustical microphone.

### SUMMARY OF THE INVENTION

Generally, the first embodiment of the invention relates to the employment of a non-acoustical transducer embodying one non-acoustical sensor (or more non-acoustical sensors) but adapted to sense acoustical sounds. Specifically, the invention involves the one sensor (or more sensors for various variations) adapted to sense acoustics replacing the microphone (or multiplicity of microphones) for realizing an ANC device. Compared to the prior-art of the application of microphones, the invention provides for a more linear phase response, higher directivity with small form-factor, and good sensitivity in the infrasound range—collectively, higher active noise cancellation, including in the infrasound range. The theory or design are for ANC, including both analog and digital processing, and the application of one or more microphones is well documented. However, prior-art ANC devices have not employed a non-acoustical sensing sensor (but adapted to sense acoustical sounds) to replace the acoustical microphone.

The second embodiment of the invention relates to the employment of the non-acoustical transducer to sense its usual designed (by the manufacturer of the non-acoustical transducer) functionality, i.e., not adapted to sense acoustical sounds. This usual designed functionality is typically either sensing vibrations, shock, or movement or acceleration, or a combination thereof—not adapted to sense acoustics.

For purposes of illustration of the invention, sensing vibration is employed, involving an accelerometer or vibration sensor. In the first variation of the second embodiment, the accelerometer or vibration sensor is adapted to be placed such that it senses audio-frequency and infrasound vibrations in/on the body (or ear canal or face) of the user of the ANC device. With this sensed signal, the ANC now provides for noise cancellation (by generating a out-of-phase output) by two sensing means. One is provided by the first embodiment of the invention involving acoustics sensed by the non-acoustical transducer but adapted to sense acoustics. Two is provided by the accelerometer or vibration sensor.

In the second variation of second embodiment, the accelerometer or vibration sensor is adapted to be placed such that it senses the user's voice. This is to correct for the problem arising from the noise cancellation provided by the ANC when the user speaks—the speaker is unable to properly estimate/perceive the volume of his voice when he talks. With this sensed signal, the ANC now provides for two additional features—either amplify his speech to account for the noise reduction or provide attenuation to his voice to provide even higher acoustical noise attenuation.

The summary does not describe an exhaustive list of all aspects of the present invention. It is anticipated that the present invention includes all methods, apparatus and systems that can be practiced from all appropriate combinations and permutations of the various aspects in this summary, as well as that delineated below. Such combinations and permutations may have specific advantages not specially described in this summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an’ or “one” embodiment of the invention herein are not necessarily to the same embodiment, and they mean at least one.

FIG. 1(a)-(d) are prior-art diagrams. FIG. 1(a) depicts a diagram of a human pinna, ear canal and tympanic membrane. FIG. 1(b) depicts the ANC device in the form a earphone that is inserted into the ear canal. FIGS. 1(c) and 1(d) depict the ANC device in the form a headphone where one of the cups of the headphone sits on the pinna and over the pinna, respectively.

FIG. 2(a) depicts the schematic block diagram of a prior-art ANC device embodying an acoustical microphone. FIG. 2(b) depicts the schematic block diagram of another prior-art ANC embodying two acoustical microphones.

FIGS. 3(a)-3(c) depicts the first embodiment of the invention. FIG. 3(a) depicts the first variation of the first embodiment of the invention where in the schematic block diagram of the invented ANC device, a non-acoustical sensor is employed where it is adapted to sense acoustical sounds. This non-acoustical sensor replaces the acoustical microphone in FIG. 2(a). FIG. 3(b) depicts the second variation of the first embodiment of the invention where in the schematic block diagram of the invented ANC, there is an acoustical microphone and a non-acoustical sensing sensor that is adapted to sense acoustical sounds. FIG. 3(c) depicts the third variation of the first embodiment of the invention where in the schematic block diagram of the invented ANC, there are two non-acoustical sensing sensors that are adapted to sense acoustical sounds, and replace the two microphones in FIG. 2(b).

FIG. 4(a) depicts the magnitude frequency response of the sensor in the non-acoustical microphone adapted to sense acoustics and that of a typical prior-art acoustical microphone, including in the infrasound range. FIG. 4(b) depict the high directivity of the non-acoustical microphone adapted to sense acoustics,

FIGS. 5(a)-5(b) depicts the second embodiment of the invention. FIG. 5(a) depicts the invented ANC device in the form of a earphone inserted into the ear canal of the user. The invented ANC now further embodies a non-acoustical sensor to sense vibrations on or in the body of the user of the ANC device—the non-acoustical sensor unlike FIGS. 3(a)-3(c) is not adapted to sense acoustics. FIG. 5(b) depicts the schematic block diagram of the invented ANC device in FIG. 5(a).

### DETAILED DESCRIPTION

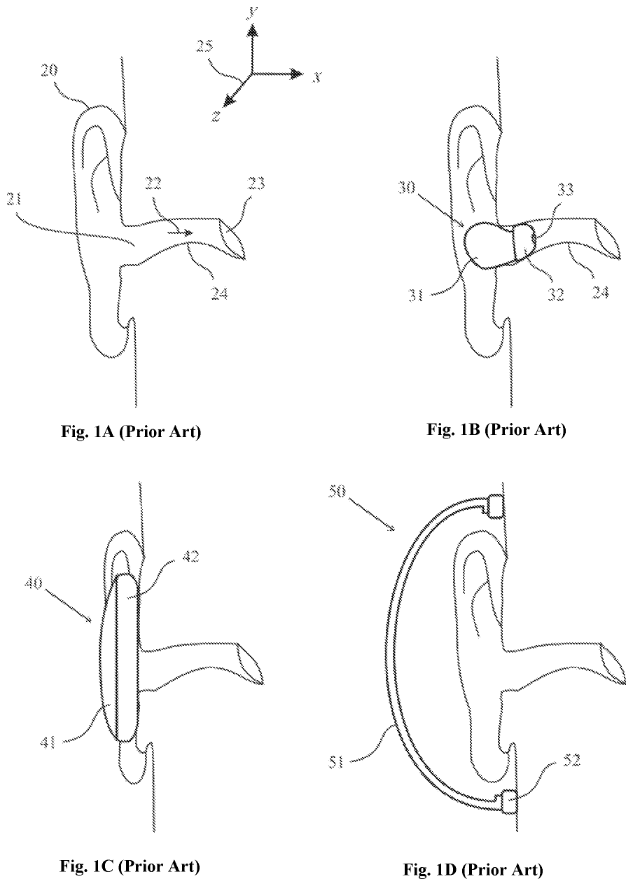

Numerous specific details are set forth in the following descriptions. It is however understood that embodiments of the invention may be practiced with or without these specific details. In other instances, circuits, structures, methods and techniques that are known do not avoid obscuring the understanding of this description. Furthermore, the following embodiments of the invention may be described as a process, which may be described as a flowchart, a flow diagram, a structure diagram, or a block diagram. The operations in the flowchart, flow diagram, structure diagram or block diagram may be a sequential process, parallel or concurrent process, and the order of the operations may be re-arranged. A process may correspond to a technique, methodology, procedure, etc. FIGS. 1(a)-(d) are prior-art diagrams of a human ear and various types of ANC devices. FIG. 1(a) depicts the human ear with Pinna 20, Ear Canal 21, Tympanic Membrane 23 and Surface of Ear Canal 24. The orientation of the Axes 25 is depicted on the top right-side of FIG. 1(a). FIG. 1(b) depicts the same ear in FIG. 1(a) with Earphone ANC Device 30 inserted into Ear Canal 21. The Earphone ANC Device 30 comprises an Enclosure 31 and an In-Ear Insert 32 which is usually a rubber mushroom-type structure. The acoustical output of Earphone ANC Device 30 is via Acoustical Output Port 33. FIG. 1(c) depicts one side of an ANC Headset 40 where Speaker-Cup-Assembly 41 sits on Pinna 20. Cushion 42 is sandwiched between Speaker-Cup-Assembly 41 and Pinna 20. FIG. 1(d) depicts one side of another ANC Headset 50 comprising Cup 51 and Cushion 52. Cup 51 and Cushion 52 covers Pinna 20.

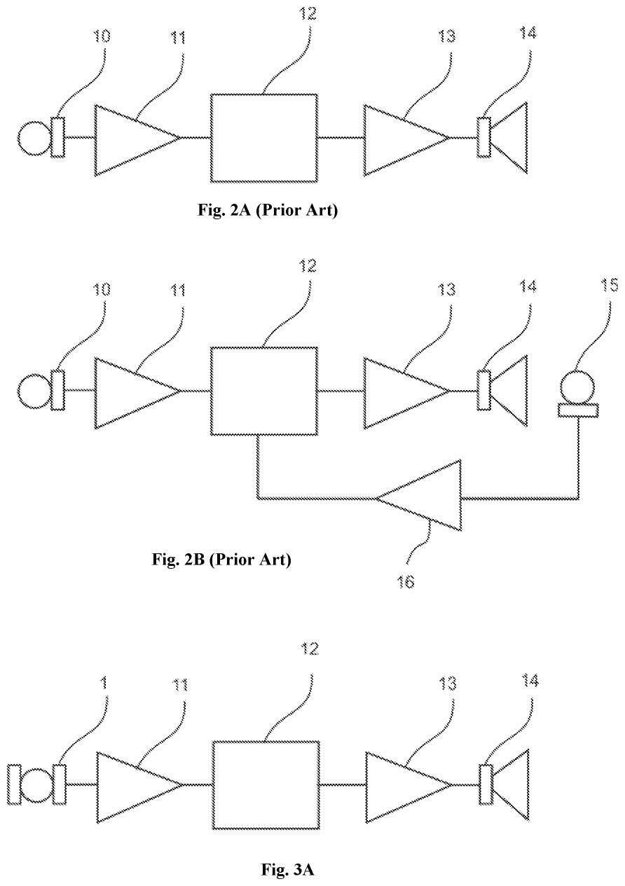

FIG. 2(a) depicts the block schematic diagram of a prior-art ANC device embodying a single acoustical microphone. Acoustical Microphone 10, usually placed as an external microphone (on the external enclosure of a headphone/earphone), serves to pick up the environmental noise and its output is amplified by Preamplifier 11. Signal Processor 12 serves to invert the amplified output of Acoustical Microphone 10 and this usually includes some filtering (magnitude and phase filtering) to correct (compensate) for the phase response of Acoustical Microphone 10 and Loudspeaker 14. The output of Speech Processor 12 is amplified by Power Amplifier 13 which drives Loudspeaker 14. Ideally, phase of the sound produced by Loudspeaker 14 is 180° out of phase (i.e., anti-phase) with respect to the environmental sound picked by Acoustical Microphone 10, thereby providing active noise cancellation/reduction.

FIG. 2(b) depicts the block schematic diagram of a prior-art ANC device embodying two single acoustical microphones. In this case, Acoustical Microphone 10 is usually placed as an external microphone that senses the environmental sound that are outside of the headphone/earphone enclosure. Acoustical Microphone 15, on the other hand, is usually placed as an internal microphone that senses the environmental sound within the headphone/earphone enclosure, sometimes in front of Loudspeaker 14. The output of Acoustical Microphone 15 is amplified by Preamplifier 16 whose output is connected to Signal Processor 12. In general, the noise reduction of this two-acoustical microphone ANC device in FIG. 1 (b) is higher than that of the single acoustical microphone ANC device in FIG. 1(a).

There are many prior-art ANC design architectures, including analog, digital and mixed-signal designs. The design architectures depicted in FIGS. 2(a) and (b) are prior-art open-loop architectures and other prior-art architectures include closed-loop and mixed open-loop-cum-closed-loop architectures.

A commonality amongst all prior-art ANC design architectures is the application of Acoustical Microphones 10 or 15.

The crux of the present invention is the application of non-acoustical transducers to ANC devices in two embodiments. The first embodiment of the invention involves replacing the Acoustical Microphone 10 (or/and 15) in prior-art ANC devices depicted in FIGS. 2(a) and 2(b) with a non-acoustical transducer, that embodies a vibration sensor, shock sensor, or movement sensor or acceleration sensor, or a combination thereof. In this case, the sensor in the non-acoustical transducer is arranged to be able to sense acoustical sounds for the invented ANC device.

The second embodiment of the invention also involves the application of a non-acoustical transducer to the ANC device. However, in this second embodiment, the functionality of the sensor in the non-acoustical transducer is what it is designed for, e.g., as an accelerometer, i.e., not adapted to sense acoustical sounds.

For sake of presentation, the term “sensor” will be used, and a “transducer” may comprise one or more sensors. The first and second embodiments of the invention will now be delineated.

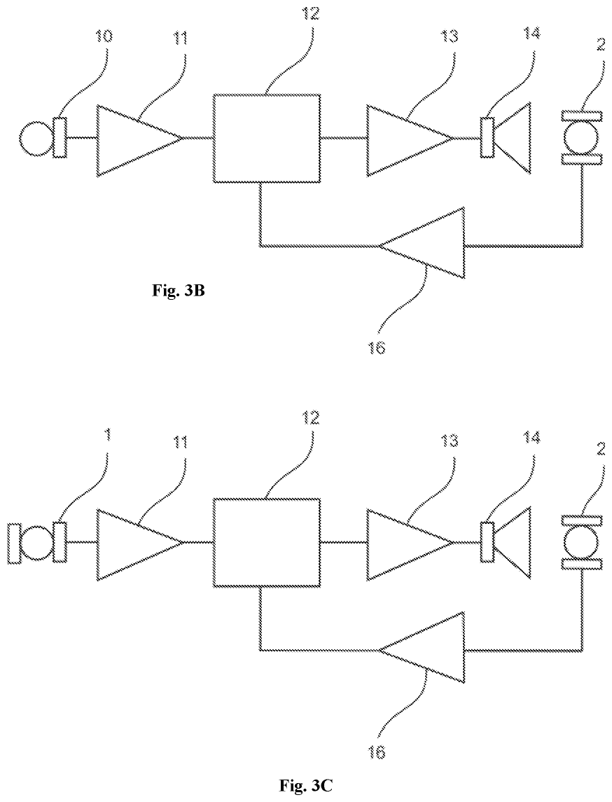

FIG. 3(a) depicts the first variation of the first embodiment of the invention. The schematic block diagram of this first embodiment for an ANC device is similar to the prior-art ANC device in FIG. 2(a) save for the replacement of Acoustical Microphone 10 with Non-Acoustical Sensor 1. As explained earner, Non-Acoustic Sensor 1 is generally a non-acoustical sensor, e.g., an accelerometer, shock sensor, gyroscope, vibration microphone, or vibration sensor but instead of its original sensing application, it is arranged in this invention to sense acoustical sounds for an ANC device.

This arrangement to adapt the non-acoustical sensor, e.g., an accelerometer, to sense acoustics is largely realized by allowing at least one surface of the enclosure of the non-acoustical sensor to be open to free-air, i.e., air pressure changes in air arising from acoustical sounds can be sensed by at least one said surface of the non-acoustic sensor. In other words, the non-acoustical sensor is not fully embedded in another housing such that none of its surfaces can sense the air pressure changes, i.e., acoustical sounds.

In FIG. 3(a), Non-Acoustical Sensor 1 senses the environmental acoustics, e.g., noise, and its output is amplified by Preamplifier 11, Signal Processor 12 serves to invert the amplified output of Non-Acoustical Sensor 1 and this usually includes some filtering (magnitude and phase filtering) to correct (compensate) for the phase response of Non-Acoustical Sensor 1 and Loudspeaker 14. The output of Speech Processor 12 is amplified by Power Amplifier 13 which drives Loudspeaker 14. With respect to FIG. 1(b), the output of the loudspeaker is via Acoustical Output Port 33 of ANC Device 30.

Compared to the prior-art ANC device in FIG. 2(a), the required phase frequency response compensation in the invented ANC Device in FIG. 3(a) is lesser because the phase of non-acoustical sensors is more Hear throughout the frequency range. Further the demands of the magnitude (frequency response) filtering in Signal Processor 12 in FIG. 2(a) are alleviated because the magnitude frequency response of most non-acoustical sensors when attenuated in the high frequencies suffer from less phase linearity distortions.

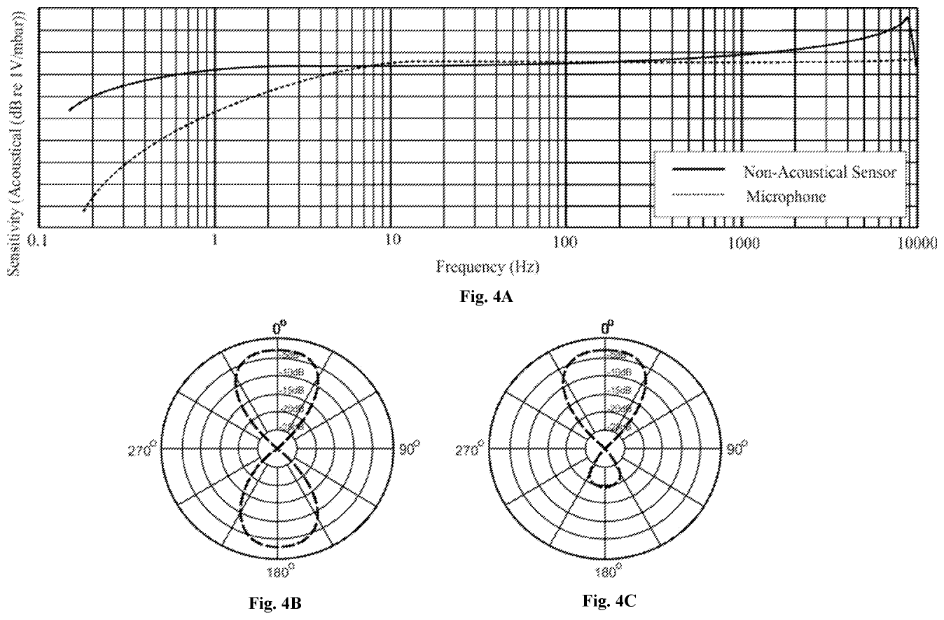

There are other advantages. First, non-acoustical sensors adapted to sense acoustics can feature significantly higher sensitivity in the infrasound frequency range than acoustical microphones; infrasound frequencies are frequencies below the human hearing range, i.e., below 20 Hz. This is depicted in FIG. 4(a) where below 10 Hz, the sensitivity of acoustical microphones is typically heavily attenuated compared to that of a non-acoustical sensor adapted to sense acoustics. Because of the undesired heavy attenuation, prior-art ANC devices are unable to offer active noise cancellation in a large frequency range of the infrasound range. This is unlike the invented ANC device that employ a non-acoustical sensor adapted to sense acoustics.

Second, non-acoustical sensors such as accelerometers adapted to sense acoustics are significantly more directive than general acoustical microphones, particularly single acoustical-port microphones which are generally omni-directional. For example, FIG. 4(b) depicts the very high directivity of a non-acoustical sensor adapted to sense acoustics.

The directivity of a non-acoustical sensor adapted to sense acoustics can be made even more directive such as that depicted in FIG. 4(c) where the sensitivity in the direction of 180° azimuth is substantially less sensitive than to 0° azimuth. This higher directivity can be achieved by mechanically blocking the non-acoustic sensor in the 180° azimuth direction.

By means of the increased directivity, the noise sensed by a non-acoustical sensor adapted to sense acoustics—Non-Acoustic Sensor 1 in FIG. 3(a) that is generally placed as an external microphone on the enclosure—can be better estimate the noise at the entrance of Ear Canal 21 (FIG. 1(a)) of the user. This better estimate of noise from Non-Acoustical Sensor 1 in FIG. 3(a) over Acoustical Microphone 10 in FIG. 2(a) provides for higher noise reduction by the invented ANC.

In short, the invented ANC embodying the first embodiment of the invention in FIG. 3(a) provides for higher noise reduction/cancellation than the prior-art ANC in FIG. 2(a).

FIG. 3(b) depicts the second variation of the first embodiment of the invention—for a different ANC design. The schematic block diagram of this different ANC design is similar to prior-art ANC design in FIG. 2(b) save for the replacement of the second acoustical microphone, Acoustical Microphone 15, with Non-Acoustical Sensor 2 which is adapted to sense acoustics.

FIG. 3(c) depicts the third variation of the first embodiment of the invention. The schematic block diagram of this third variation is also similar to prior-art ANC in FIG. 2(b) save for the replacement of both acoustical microphones, Acoustical Microphone 10 and Acoustical Microphone 15, with non-acoustical sensors, Non-Acoustical Sensor 1 and Non-Acoustical Sensor 2, respectively. The two non-acoustical sensors, Non-Acoustical Sensor 1 and Non-Acoustical Sensor 2, are adapted to sense acoustics.

Although not shown pictorially, various non-acoustical sensors can be arranged such that their directivity is not necessarily in the direction of the ear canal as depicted as Direction 22 in FIG. 1(a). Direction 22 is shown as the direction in the x-axis in Axes 25, also in FIG. 1(a). For example, another non-acoustical sensor arranged to sense acoustics may be arranged such that the direction of highest sensitivity is in the z-axis in Axes 25. Being able to sense different directions would provide the invented ANC Device 30 with added features.

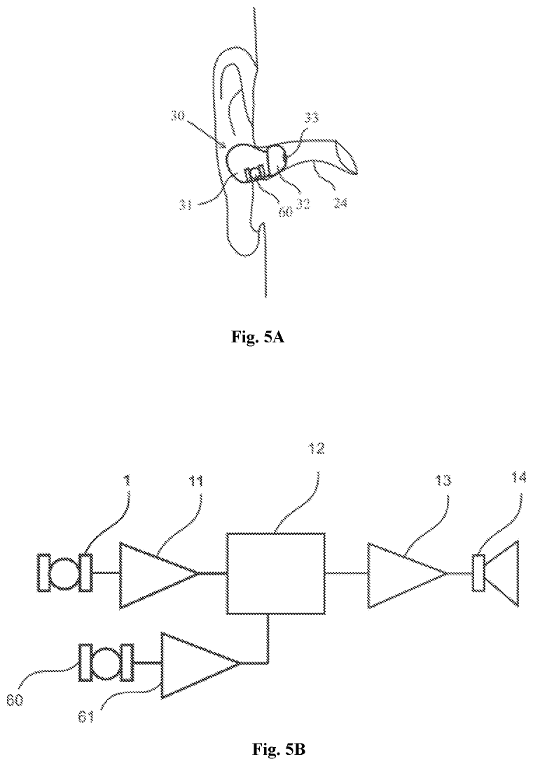

FIG. 5(a) depicts the second embodiment of the invention where Non-Acoustical Sensor 60 is embedded into Earphone ANC Device 30. In this first variation of the second embodiment of the invention, Non-Acoustical Sensor 60 is not adapted to sense acoustics but to sense acceleration or vibrations on the skin or in the body of the user due to the ambient environmental noise that is mechanically coupled to the user's body. Non-Acoustical Sensor 60 is placed within Enclosure 31 in FIG. 1(b). The acceleration/vibrations sensed are audio-frequency and infrasound vibrations in/on the body (including in Ear Canal 21 in FIG. 1(a)) of the user of the invented ANC device 30. The acceleration/vibrations are mechanically coupled to Non-Acoustical Sensor 60 via Enclosure 31 and In-Ear Insert 32 of the invented ANC Device 30 in FIG. 1(b).

FIG. 5(b) depicts the block diagram schematic of Earphone ANC Device 30 depicted in FIG. 5(a). This block schematic is based on the block schematic of the invented ANC device 30 earlier depicted in FIG. 3(a). The augmentation here is Non-Acoustical Sensor 60 that senses acceleration or vibrations on the skin or in the body of the user due to ambient environmental noise, and its output is preamplified by Preamplifier 61. The output of Preamplifier 60 is processed by Signal Processor 12. With this sensed signal, the ANC device now provides for noise cancellation by two sensing means. One is provided by the first embodiment of the invention involving acoustics sensed by Non-Acoustical Sensor 1 but adapted to sense acoustics. Two is provided by the accelerometer or vibration sensor—Non-Acoustical Sensor 60. Note that the processing of the outputs of Non-Acoustical Sensor 1 and 2 by Signal Processor 12 may be different. The augmentation of Non-Acoustic Sensor 60 and Preamplifier 61 may similarly be applied to various ANC design architectures, including the invented block diagrams depicted FIGS. 3(b) and 3(c).

In the second variation of the second embodiment, the accelerometer or vibration sensor—Non-Acoustical Sensor 60—is adapted to be placed such that it senses the user's voice. With this sensed signal, the invented ANC device now provides for two additional features. One, as delineated earlier, because of the noise cancellation provided by the ANC device, the speaker (i.e., the user of the ANC device) is unable to estimate the volume of his voice when he talks. By means of Non-Acoustical Sensor 60, the invented ANC can now either amplify his speech to account for the noise reduction or provide attenuation to his voice to provide even higher acoustical noise reduction/cancellation.

The aforesaid descriptions of the embodiments of the invention were largely described for the application of an ANC device realized as a earphone ANC device that is inserted into the ear canal as depicted in FIG. 1(b) or FIG. 5(a). The first and second embodiments of the invention and their variations can similarly be advantageously applied to headphone-type ANC devices, such as that depicted in FIGS. 1(c) and 1(d).

The aforesaid descriptions are merely illustrative of the principles of this invention and many configurations, variations, and various modifications can be made by those skilled in the art without departing from the scope and spirit of the invention. The foresaid embodiments may be designed, realized and implemented individually or in any combination or permutations.

### REFERENCES

Colin Hansen
Understanding Active Noise Cancellation
ISBN-13: 978-0415231923
P Darlington, et al.
In-ear Device Incorporating active Noise Reduction
US20130058493A1
A Ibrahim
Selective Noise-Cancelling Earphone
US20150294662A1

1. An active noise cancellation system, comprising a non-acoustical transducer having one sensor, where
the one sensor is sensitive to either vibrations, shock, or movement or acceleration, and
adapted to sense acoustical sounds.

2. An active noise cancellation system as cited in claim 1, where
the frequency response of the one sensor extends to the infrasound range.

3. An active noise cancellation system as cited in claim 2, where
the infrasound range includes 4 Hertz or lower.

4. An active noise cancellation system as cited in claim 1, where
the one sensor is sensitive or most sensitive in the direction of one axis.

5. An active noise cancellation system as cited in claim 4, where
the one axis is arranged to be a direction resembling that directed or parallel to the ear canal of the user of the active noise cancellation system.

6. An active noise cancellation system as cited in claim 4, where
the one sensor is adapted to be more sensitive to one direction of the one axis than the opposite direction of the one axis.

7. An active noise cancellation system as cited in claim 4, where
the non-acoustical transducer further having a second sensor, and
the second sensor is
sensitive to either vibrations, shock, movement, acceleration, or adapted to be sensitive to acoustical sounds, and
sensitive or most sensitive in the direction of a second axis.

8. An active noise cancellation system as cited in claim 7, where
the second axis is arranged to resemble a direction that is either
perpendicular to the one axis,
parallel to the one axis, or
any other direction.

9. An active noise cancellation system as cited in claim 7, where
the non-acoustical transducer further having a third sensor,
and the third sensor is
sensitive to either vibrations, shock, movement, acceleration, or adapted to be sensitive to acoustical sounds, and
sensitive or most sensitive in the direction of a third axis.

10. An active noise cancellation system as cited in claim 1 further comprising
a earcup or a earphone or a ear insert that is acoustically coupled to the ear of the user.

11. An active noise cancellation system as cited in claim 1, further comprising a processor and a loudspeaker.

12. An active noise cancellation system as cited in claim 11, where
the one sensor outputs a signal,
the processor processes the output of the one sensor and outputs a signal to the loudspeaker, and
the phase response of the acoustic output of the loudspeaker resembles an out-of-phase or anti-phase with respect to the output signal of the one sensor.

13. An active noise cancellation system as cited in claim 12, where
the frequency response of the acoustical output of the loudspeaker extends into the infrasound range.

14. An active noise cancellation system as cited in claim 7, where
the second axis is arranged to be in a direction resembling that which is perpendicular to the surface of the ear canal of the user of the active noise cancellation system.

15. An active noise cancellation system as cited in claim 14, where
the second sensor senses a signal resembling the vibrations in or on the body of the user of the active noise cancellation system.

16. An active noise cancellation system as cited in claim 15 further comprising a processor and a loudspeaker, where
the second sensor outputs a signal,
the processor processes the output of the second sensor and outputs a signal to the loudspeaker,
the phase response of the acoustical output of the loudspeaker is arranged such that the user of the active noise cancellation system perceives active noise cancellation with respect to the signal sensed by the second sensor.

17. An active noise cancellation system as cited in claim 4, where
the non-acoustical transducer further having a second sensor, and
the second sensor is adapted to be sensitive to either vibrations, shock, movement,
or acceleration on the skin of the user of the active noise cancellation system.

18. An active noise cancellation system as cited in claim 17 further comprising a processor and a loudspeaker, where
the second sensor senses a signal resembling the voice of the user of the active noise cancellation system and outputs a signal,
the processor processes the output of the non-acoustic sensor and outputs a signal to the loudspeaker,
the phase response of the acoustic output of the loudspeaker is arranged such that
the user of the active noise cancellation system either perceives
active noise cancellation with respect to the signal sensed by the second sensor, or
amplifies the signal sensed by the second sensor.

19. An active noise cancellation system as cited in claim 1 further comprising one or a multiplicity of microphones.

20. An active noise cancellation system as cited in claim 1, where the phase response of the one sensor resembles a linear phase response in its passband and in at least a range in the stopband magnitude frequency response.
